(19) United States
(12) Patent Application Publication
(10) Pub. No.: US 2006/0152558 A1
(43) Pub. Date: Jul. 13, 2006

(54) Fluid drop ejection

(76) Inventor: Paul A. Hoisington, Norwich, VT (US)

Correspondence Address: FISH & RICHARDSON P.C., PO BOX 1022, MINNEAPOLIS, MN, 55440-1022, US

(21) Appl. No.: 11/031,439

(22) Filed: Jan. 7, 2005

(51) Int. Cl. B41J 2/17

(52) U.S. Cl. 347/84

(57) ABSTRACT

A drop ejection system includes a flow regulator that can regulate the fluid flow to enhance fluid purging from the fluid ejection head and other system operations. The drop ejection system can include a drop ejection head with a plurality of nozzles, a pumping chamber, and a fluid purge unit capable of purging the fluid from the nozzles by generating a negative pressure outside of nozzles. The flow regulator can increases the flow resistance of the fluid flow to the drop ejection head when the fluid is purged out of the nozzles.

### TECHNICAL FIELD

This application relates to the field of fluid drop ejection.

### BACKGROUND

In many ink jet systems, ink is supplied to a chamber or passage connected to an orifice from which the ink is ejected drop-by-drop as a result of successive cycles of decreased and increased pressure applied to the ink in the passage, usually by a piezoelectric crystal having a pressure-generating surface communicating with the passage. If the ink introduced into the passage contains dissolved air, decompression of the ink during the reduced pressure portions of the pressure cycle may cause the dissolved air to form small bubbles in the ink within the passage. Repeated decompression of the ink in the chamber causes these bubbles to grow and such bubbles can produce malfunctions of the ink jet apparatus. Also, bubbles can be introduced into the ink passages by ingestion at the nozzle, flowing in from the reservoir or can form as the ink temperature is cycled because temperature affects the solubility of air in the jetting fluid. For example, if water based jetting fluid is saturated with air and then heated, the solubility of air in the fluid will be reduced, making it supersaturated and prone to forming bubbles.

Bubbles that accumulate in the ink jet head can be removed by purging the ink jet print heads so that the purged ink carries the air bubbles out of the ink nozzles. In general, larger bubbles are more easily purged with ink fluid than the smaller bubbles. Large bubbles will cover a region where flow velocities are higher whereas small bubbles are more easily trapped in a corner or can adhere to a wall where the flow velocities are lower. As the bubble grows to a significant fraction of the channel size, the flow velocity increases in the vicinity of the bubble because the flow channel is constricted by the bubble. This further increases the pressure drop across the bubble making it more likely to move.

Ink jet print heads are conventionally purged by two approaches: a) by pressurizing the ink supply to force ink to vent out of ink nozzles, or b) by applying a nozzle cap to the nozzle plate to suck ink through the nozzles.

U.S. Pat. No. 4,419,677, U.S. Pat. No. 4,658,274, and commonly assigned U.S. Pat. No. 4,937,598 discloses an ink supply systems wherein a pump generates and applies pressure to the ink in the reservoirs to eject ink out of the ink jet head through the orifices, thereby carrying the trapped air with it. Such outflow purging systems necessarily require relatively high-capacity ink nozzle capture and cleaning devices to collect and remove the substantial quantities of ink that is ejected through the orifices during purging processes.

The pressure purge method pressurizes the ink fluid in the print head and reduces the size of air bubbles in the ink fluid, which makes it more difficult to purge the air bubbles. The effectiveness of removing air bubbles using pressure ink purge is therefore fundamentally limited.

### SUMMARY

In one aspect, a drop ejection system is disclosed. The drop ejection system includes a drop ejection head comprising a plurality of nozzles for ejecting a fluid, a pumping chamber adapted to supply the fluid to the drop ejection head, a fluid purge unit capable of purging the fluid from the nozzles by generating a negative pressure outside of nozzles, and a flow regulator that can increases the flow resistance of the fluid flow to the drop ejection head when the fluid is purged out of the nozzles.

In another aspect, a method for purging the ink jet print head is disclosed. The method includes supplying ink from the pumping chamber to an ink jet print head, increasing the flow resistance of the ink passage supplying ink to the pumping chamber; purging ink from the ink jet nozzles of the ink jet print head, and reducing the flow resistance of the ink passage supplying ink to the pumping chamber.

In still another aspect, a method for purging a fluid ejection system includes supplying a fluid along a fluid path to a fluid ejection head including fluid ejection nozzles; increasing the flow resistance to the fluid upstream of a region along the fluid path; and purging the fluid from the region along a fluid path.

Implementation of the system and method may include one or more of the following. The drop ejection head can be an ink jet print head comprising a plurality of ink jet nozzles adapted to eject an ink fluid. The flow regulator can regulate ink flow into the pumping chamber. The flow regulator can be a passive device or an active device. The flow regulator can be controlled by a control unit in response to the modes of operation of the ink jet printing system. The flow regulator can include one or more of a variable valve, solenoid valves, servo valves, or a flow resistance in parallel to an open/shut bypass valve. The ink purge unit can include a nozzle cap that can air-tight seal the ink jet nozzles from the ambient air, and a pump that can pump air out of the air-tight space formed by the nozzle cap and the ink jet print head, thereby generating the negative pressure for purging ink out of the ink jet nozzles. A mechanism can move the nozzle cap to engage with and disengage from the ink jet nozzles. The ink purge unit can purge ink from a subset of the ink jet nozzles in an ink jet print head. A deaerator can be in fluid contact with the ink along an ink path supplying ink to the ink jet print head, and the deaerator may remove dissolved gas from the ink fluid. The ink jet printing system can further comprise an ink receiver for receiving ink drops ejected from the ink jet nozzles and a transport mechanism for producing relative movement between the ink jet print head and the ink receiver. An ink reservoir can store the ink to be supplied to the pumping chamber. The flow regulator can be located along the ink path between the ink reservoir and the pumping chamber, in the ink reservoir, or along an ink path connected with an inlet to the ink reservoir.

Implementation of the system and method may include one or more of the following. The flow resistance to the ink along the ink path is increased before or during purging ink from the ink jet nozzles of the ink jet print head. The flow resistance to the ink along the ink path is decreased during or after purging ink from the ink jet nozzles of the ink jet print head. The method further includes one or more of tracking the duration of the idle time of the ink jet print head, tracking the acceleration of the ink jet print head, and tracking the ink filling status of the ink jet print head.

Embodiments may include one or more of the following advantages. An ink jet head with a purging arrangement improves the conventional suck-type purge method for ink jet print heads. A flow regulator can increase the flow resistance of ink flow upstream of the pumping chamber during ink purge so that the pressure drop in the pumping chamber is increased. As a result, air bubbles in the ink in the pumping chamber can expand and can therefore be more effectively removed.

Another possible advantage is that a simple and reliable mechanism can be provided for removing air bubbles from an inkjet printing system. The system and methods can enhance or remove the need for degassing systems.

Another possible advantage is that an air removal arrangement can be provided that is more effective than pressurizing approaches or conventional suction-type approaches. Air bubbles can therefore be removed more thoroughly from the fluid.

Still another possible advantage is that air bubbles can be effectively removed from pumping station and/or ink reservoirs. In comparison, systems without flow regulators have a large pressure drop at the ink nozzle exits and thus are less effective at removing bubbles within the ink jet print heads. In this invention, the bubbles can be expanded in the pumping chamber and the bubbles can be removed along a longer stretch of ink passage supplying ink to the print head. Because bubbles in a larger ink volume can be removed at each ink purging, the ink purging operations can be less frequent, thus reducing maintenance down time and increasing system throughput as well as reducing ink waste.

Yet another possible advantage is that the effectiveness of ink purging can be improved without sacrificing the effectiveness of the ink jet printing operation.

The details of one or more embodiments are set forth in the accompanying drawings and in the description below. Other features, objects, and advantages of the invention will become apparent from the description and drawings, and from the claims.

### BRIEF DESCRIPTION OF THD DRAWINGS

FIG. 1 is a block diagram of an ink jet printing system having an ink purge unit.

FIG. 2 illustrates the cross-section of a flow restrictor that is compatible with the ink purge unit in FIG. 1.

### DETAILED DESCRIPTION

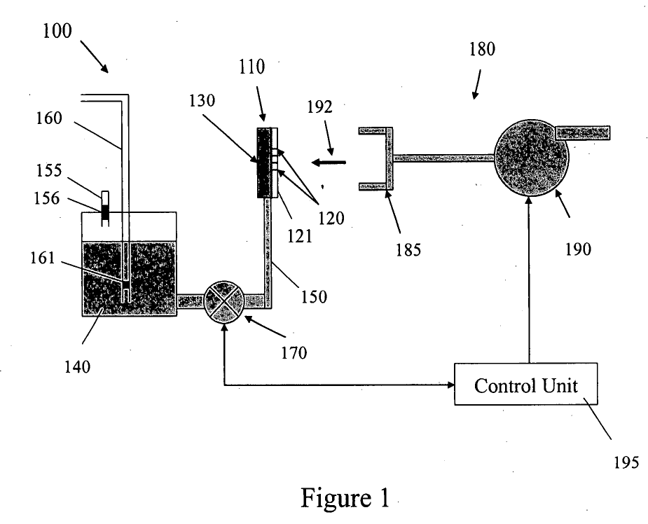

As shown in FIG. 1, an ink jet printing system 100 includes an ink jet print head module 110 having a plurality of ink nozzles 120 typically arranged in arrays on a nozzle plate 121 and a pumping chamber 130 for supplying ink to the nozzles 120, an ink reservoir 140 for storing the ink to be supplied to the pumping chamber 130, and an ink passage 150 that provides fluid connection between the ink reservoir 140 and the pumping chamber 130. During printing, ink drops are ejected from the ink nozzles 120 in response to input image data to form an image ink dot pattern on an ink receiver.

The ink jet print head module 110 can exist in the form of piezoelectric ink jet, thermal ink jet, MEMS based ink jet print heads, and other types of ink actuation mechanisms. For example, Hoisington et al. U.S. Pat. No. 5,265,315, the entire content of which is hereby incorporated by reference, describes a print head that has a semiconductor print head body and a piezoelectric actuator. The print head body is made of silicon, which is etched to define ink fluid conduits. Nozzle openings are defined by a separate nozzle plate 121, which is attached to the silicon body. The piezoelectric actuator has a layer of piezoelectric material, which changes geometry, or bends, in response to an applied voltage. The bending of the piezoelectric layer pressurizes ink in a pumping chamber located along the ink path. Other ink jet print heads are disclosed in above mentioned and commonly assigned U.S. patent application Ser. No. 10/189,947, US Patent Publication No. US20040004649A1, titled “Printhead”, filed on Jul. 3, 2002 and U.S. Provisional Patent Application No. 60/510,459, titled “Print head with thin membrane”, filed Oct. 10, 2003. The content of these related patent applications and publications are herein incorporated by reference.

The ink reservoir 140 includes an ink-feeding path 160 having an ink filter 161 that supplies ink to the ink reservoir 140. The ink reservoir 140 also has an air inlet 155 having an air filter 156 that allows the ink level to vary in the ink reservoir 140. An ink flow regulator 170 located along the ink passage 150 between the ink reservoir and the pumping chamber 130 is capable of varying ink flow resistance in the ink passage 150. Different ink types such as water based inks, solvent based inks, hot melt inks, dye or pigmented inks can be used in the ink jet printing system 100.

The flow regulator 170 is capable of changing flow resistance depending the mode or steps of operation. The flow regulator 170 can be an active device under the control of the control unit 195, or a stand-alone passive device.

The hydrostatic pressure in the ink conduit including the ink pump chamber 130, the ink reservoir 140, and ink passage 150 is controlled for proper ink jet printing and ink purging operations. Insufficient (or too negative) hydrostatic pressure at the ink jet nozzles 120 can cause the ink meniscus to retract within the ink jet nozzles 120. On the other hand, excessive hydrostatic pressure at the ink jet nozzles 120 can cause the ink to leak from the ink jet nozzles 120, producing ink flooding on the nozzle plate 121. The pressure of air over the fluid in the reservoir is typically controlled to keep the pressure at the nozzles slightly below atmospheric pressure (e.g. at −1 inch to −4 inches of water).

The ink jet printing system 100 can also include a mechanism (not shown) that provides the relative movement between the ink jet print head module 110 and an ink receiving media. In one embodiment, the ink jet print head module 110 can move in reciprocating motion along a first direction driven by a motor via an endless belt. The direction of the motion is often referred as the fast scan direction. A second mechanism can transport the ink receiving media along a second direction (slow scan) that is perpendicular to the first direction. During the ink jet printing operations, the ink jet print head module 110 disposes ink drops to form a swath of ink dots on the ink receiving media. In another embodiment, a page-wide ink jet print head module 110 is formed by a print head bar or an assembly of print head modules. The ink jet print head module 110 remains still during printing while the ink receiving media is transported along slow scan direction under the ink jet print head module 110. The ink purge system and methods are compatible with different print head arrangements known in the art. For example, the ink jet printing system 100 is applicable to a single pass ink jet printer with offset ink jet modules disclosed in the commonly assigned U.S. Pat. No. 5,771,052, the content of which is incorporated herein by reference.

The ink jet printing system 100 also includes an ink purge unit 180. The ink purge unit 180 includes a nozzle cap 185 that can seal the ink jet nozzles 120 air tight from the ambient air. The ink purge unit 180 also includes a suction pump 190 that can pump air out of the air-tight space formed by the nozzle cap 185 and the nozzle plate 121 under the control of control unit 195, which generates the negative pressure outside of the ink jet nozzles for purging ink out of the ink jet nozzles. The ink purge unit 180 further includes a mechanism (not shown) that can move the nozzle cap 185 along direction 192 to engage the nozzle cap 185 with the nozzle plate 121 to seal the ink jet nozzles 120 air tight.

Comparing to the pressure purge methods, a suction purge method can be more effective at removing air bubbles. The suction-type purge has the advantage that it expands the air bubbles. Without the flow regulator described below, the bubble expansion, however, mostly occurs in the ink fluid in the print head and the degree of the bubble expansion is also limited. The ink pressure is only slightly reduced in the pumping chamber.

In accordance with another embodiment, a flow regulator can be installed along the ink-feeding path 160 of the ink reservoir 140. The flow regulator in this embodiment may be a valve or variable flow resistor. The flow resistance is low in normal ink feeding or ink jet printing modes. The flow resistance is increased during the purging of the ink jet print head. The ink-feeding path in this embodiment is preferably filled with ink or there is little air space in the ink reservoir 140 so that there is little or no room for the expansion of air in the ink reservoir 140. The ink pressure drop can then be achieved in the pumping chamber 130 and the ink reservoir 140 without purging excess amount of ink from the ink jet print head module 110. The effectiveness of air bubble removal in the pumping chamber is significantly improved.

In another embodiment, the resistance to ink flow can be regulated inside the ink reservoir 140. The ink reservoir 140 may include a narrow constrained ink path wherein an ink regulator such as a valve can be disposed. The resistance to ink flow can be regulated similarly as described above.

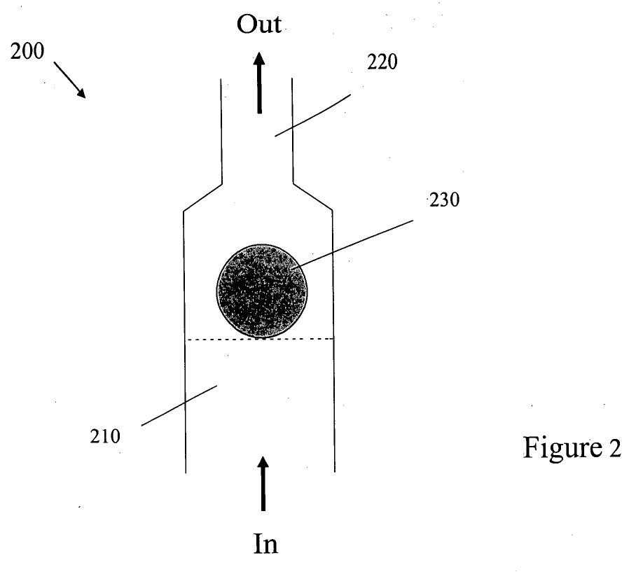

FIG. 2 illustrates a flow restrictor 200 that is compatible with the flow regulator 170 for improved suction-type purging. The flow restrictor 200 is a stand-alone passive device that increases resistance at high flow rate. The flow restrictor 200 includes a wide flow inlet channel 210 and narrow flow outlet channel 220. The flow restrictor 200 further includes a float 230. At high flow rate during ink purging for example, the flow velocity between the float 230 and the outlet channel 220 is increased and the fluid pressure decreased. The float 230 is attracted to the outlet channel 220, which therefore restricts the flow of the ink fluid.

The flow restriction by the flow regulator 170 can also be accomplished with active devices such as solenoid valves, or servo valves. A flexible tube could be compressed or pinched off by a solenoid or motor driven actuator. A check valve could be used that would become more restrictive when high flow rates were present. Variable flow restriction can be achieved by a variable valve or a flow resistance in parallel to an open/shut bypass valve. The active devices are controlled by a control unit 195 in response to the mode of operation of the ink jet printing system. In one embodiment, a flow rate sensor may be installed in the flow path to send flow information to the control unit 195 that can in turn determine control information to be sent to the flow regulator 170 to achieve the proper flow resistance for the intended operating mode (printing at different printing speeds, ink refilling mode, maintenance modes, ink purging mode, etc).

In an embodiment, the ink jet printing system 100 includes a restriction in the ink flow path that is introduced before or during purging. This restriction is upstream of the pumping chamber 130 and has a significant pressure drop across it during the suck purge. This pressure drop causes a reduced pressure in the pumping chamber 130, expanding any bubbles in it, making them easier to purge. The air bubbles in the ink fluid are more easily purged than the smaller air bubbles because small bubbles are more easily trapped in a corner or adhered to a wall where the flow velocities are lower. The expanded bubble will move to a region where flow velocities are higher and the pressure drop across the bubble is larger which helps to overcome the surface energy to make the bubble move. As the bubble grows to a significant fraction of the channel size, the flow velocity increases in the vicinity of the bubble because the flow channel is constricted by the bubble. This further increases the pressure drop across the bubble making it more likely to move. Note that the restriction upstream of the pumping chamber 130 also has the effect of reducing the pressure drop at the ink nozzle 120. The flow resistance to the ink supplied to the pumping chamber 130 is reduced after (or during) ink purging from the ink jet nozzles of the ink jet print head.

The ink jet printing system 100 operates the ink flow regulator 170 in at the least two modes: a) a low ink flow resistance mode for normal ink supply to the ink jet print head module 110, which applies to operational modes such as ink jet printing and ink refilling to the pumping chamber 130; and b) a high ink flow resistance mode for ink purging at the ink jet print head module 110 to increase the pressure drop in the pumping chamber 130 and as described above, the effectiveness of air bubble removal from the ink jet print head module 110.

One advantage is that air bubbles up stream of the print head can be effectively removed. Air bubbles are therefore more thoroughly removed in a higher volume of ink fluid or along a longer stretch of ink path. This feature allows ink purging operation to be less frequent, thus reducing maintenance down time and increasing system throughput as well as reducing ink waste.

Another advantage is that the effectiveness of ink purging is improved without sacrificing the effectiveness and quality of the ink jet printing because the ink flow to the ink jet print head module 110 is kept at low resistance during ink jet printing.

In accordance with other embodiments, the ink nozzles within an ink jet print head can be purged in sub groups. This approach will increase the flow rate through each jet, which helps purging, and also reduce the amount of ink consumed (i.e. wasted) by the purge process. The purging of a subset of ink nozzles can be accomplished by a nozzle cap member and a suction pump in conjunction with a switching mechanism. The nozzle cap member is formed with partition walls. The suction pump is driven to perform a purge operation on only the nozzle row in the partitioned chamber selected by the switching mechanism. Details of purging ink nozzles of an ink jet print head in sub groups are disclosed in U.S. Pat. No. 6,467,872, the content of which is hereby incorporated by reference. When a subset of nozzles in an ink jet print head are purged, the rest of the nozzles in the print head need to be sealed air tight so that air bubbles are not ingested into the ink through the rest of the nozzles. It should be further noted that purging ink through a subset of ink nozzles tends to increase the pressure drop at the nozzles and reduce the pressure drop in the ink conduit directly connected to the nozzles. Thus the number of ink nozzles in each subset needs to be optimized for optimal bubble removal.

In other embodiments, the ink jet printing system 100 includes a computer processor that has stored the operation history as well as rules for ink purging of the ink jet print head module 110. Typically, ink-purging operations are executed after the following events:

a) The ink jet print head module 110 has been idle for a long period during which air bubbles can form and accumulate in the ink fluid.

b) The ink reservoir 140 or the pumping chamber 130 has run out of ink and a new ink fluid needs to be refilled. The new inks if not degassed tend to bring in new air bubbles into the ink path.

c) The ink jet print head module 110 has been transported at high accelerations. For example, high acceleration of the ink jet print head module 110 can occur if the printer experiences an impact. High acceleration movement of the ink jet print head module 110 tends to cause air to be ingested at the ink jet nozzles.

The ink purging can be applied in conjunction with other print head maintenance operations such as wiping of the ink jet nozzle plate 121, firing of the ink jet nozzles, etc. For example, after purging, the ink jet nozzle plate 121 can be wiped with a blade (metal, rubber or plastic) and/or wiped with a sponge or blotter like material. The ink jet nozzle plate 121 can also be wiped with a cylindrical wiper. In addition, the maintenance unit may include a pad or a paper web to engage the orifice plate so as to receive ink ejected during purging and to clean the orifice plate after purging. Details of a maintenance unit having a pad or a paper web for receiving ink ejected during purging and to clean the orifice plate after purging are disclosed in the commonly assigned U.S. Pat. Nos. 5,557,305 and 6,357,867, the content of which is incorporated herein by reference.

In other embodiments, the purging of the ink fluid can occur at regions other than the ink jet nozzle. For example, the fluid region can include the ink reservoir, the pumping chamber, or along the fluid passages. The flow resistance to the fluid is first increased upstream of the region by a restrictor such as the one shown in FIG. 2. Air bubbles are then purged by applying negative pressure using an ink purging system (similar to 190) at a fluid exit in the region or down stream of the region along the fluid path. The flow resistance to the fluid is decreased after the purging.

The purge mechanism can also work in combination with a deaerator for removing dissolved air from the ink. Commonly assigned U.S. Pat. No. 4,940,995, the content of which is hereby incorporated by reference, discloses a device for removing dissolved gas from ink described in the specification, an elongated ink path leading to an ink jet head is formed between two permeable fluorine-containing membranes. The membranes are backed by air plenums that contain support members to hold the membranes in position. Reduced pressure is applied to the plenums to extract dissolved gas from the ink in the ink path without accumulating scum on the membrane surfaces. Increased pressure can also be applied to the plenums to eject ink from the ink jet head for purging. Within the ink jet head, ink is circulated convectively from the orifice to the deaerating path even when the jet is not jetting ink.

Although an ink jet printing system is described above, other embodiments include a drop ejection system that comprises a drop ejection head comprising a plurality of nozzles for ejecting fluid, a pumping chamber for supplying fluid to the drop ejection head, and a fluid purge unit that purges fluid from the nozzles by generating a negative pressure outside of the nozzles. A flow regulator is provided for regulating the fluid flow from the reservoir to the drop ejection head, wherein the flow regulator increases flow resistance when the fluid is purged out of the nozzles.

Ink types compatible with the ink jet printing system described include water-based inks, solvent-based inks, and hot melt inks. The colorants in the inks can comprise dye or pigment. Other fluids compatible with the system may include polymer solutions, gel solutions, solutions containing particles or low molecular-weight molecules, which may or may not include any colorant.

What is claimed is:

1. A drop ejection system, comprising:
a drop ejection head comprising a plurality of nozzles adapted to eject a fluid;
a pumping chamber adapted to supply the fluid to the drop ejection head;
a fluid purge unit capable of purging the fluid from the nozzles by generating a negative pressure outside of nozzles; and
a flow regulator that is configured to increase the flow resistance of the fluid flow to the drop ejection head when the fluid is purged out of the nozzles.

2. The drop ejection system of claim 1, wherein the drop ejection head is an ink jet print head comprising a plurality of ink jet nozzles adapted to eject an ink fluid.

3. The drop ejection system of claim 1, wherein the flow regulator is capable of regulating the fluid flow into the pumping chamber.

4. The drop ejection system of claim 1, wherein the flow regulator is a passive device.

5. The drop ejection system of claim 1, wherein the flow regulator is an active device.

6. The drop ejection system of claim 1, wherein the flow regulator is controlled by a control unit in response to the modes of operation of the drop ejection system.

7. The drop ejection system of claim 1, wherein the flow regulator includes one or more of a variable valve, solenoid valves, servo valves, and a flow resistance in parallel to an open/shut bypass valve.

8. The drop ejection system of claim 1, wherein the fluid purge unit comprises
a nozzle cap that can seal the nozzles air-tight from the ambient air; and
a pump that can pump air out of the air-tight space formed by the nozzle cap and the fluid ejection head, thereby generating the negative pressure for purging the fluid out of the nozzles.

9. The drop ejection system of claim 8, further comprising a mechanism for moving the nozzle cap to engage with and disengage from the nozzles.

10. The drop ejection system of claim 1, wherein the fluid purge unit is capable of purging the fluid from a subset of the nozzles in a fluid ejection head.

11. The drop ejection system of claim 1, further comprising a deaerator in fluid contact with the fluid along a flow path supplying fluid to the drop ejection head, wherein the deaerator is capable of removing dissolved gas from the fluid.

12. The drop ejection system of claim 1, further comprising a transport mechanism that produce relative movement between the drop ejection head and a receiver to permit the receiver to receive fluid drops ejected from the nozzles.

13. A method for purging a fluid ejection head, comprising:
supplying a fluid along a fluid path to the fluid ejection head having a plurality of nozzles;
increasing the flow resistance to the fluid along the flow path; and
purging the fluid from the fluid ejection head.

14. The method of claim 13, wherein the fluid is purged through the nozzles.

15. The method of claim 14, wherein purging the fluid from the region includes applying a negative air pressure to the nozzles.

16. The method of claim 13, wherein purging the fluid from the region includes applying a negative air pressure an outlet of the fluid ejection head.

17. The method of claim 13, wherein increasing the flow resistance to the fluid along the flow path occurs before or during purging fluid from the nozzles of the fluid ejection head.

18. The method of claim 13, further comprising reducing the flow resistance to the fluid along the fluid path.

19. The method of claim 18, wherein reducing the flow resistance to the fluid along the fluid path occurs during or after purging ink from the nozzles of the fluid ejection head.

20. The method of claim 13, further comprising determining the execution of purging the ink from the ink jet nozzles by tracking one or more of the duration of the idle time of the ink jet print head, the acceleration of the ink jet print head, and the ink filling status of the ink jet print head.

21. The method of claim 20, further comprising tracking the duration of the idle time of the fluid ejection head.

22. The method of claim 20, further comprising tracking the acceleration of the fluid ejection head.

23. The method of claim 20, further comprising tracking the fluid filling status of the fluid ejection head.

24. The method of claim 13, wherein increasing the flow resistance occurs upstream of the fluid ejection head.

25. The method of claim 13, wherein the fluid ejection head is an ink jet print head comprising a plurality of ink jet nozzles adapted to eject an ink.

26. The method of claim 25, further comprising wiping a nozzle plate of the ink jet print head.

27. The method of claim 25, further comprising ejecting ink drops from the ink jet nozzles.

28. The method of claim 25, further comprising supplying ink from an ink reservoir to a pumping chamber in the ink jet print head.

29. The method of claim 28, wherein increasing the flow resistance occurs at a passage supplying ink to the pumping chamber.
